(19) United States
(12) Patent Application Publication
(10) Pub. No.: US 2004/0148251 A1
(43) Pub. Date: Jul. 29, 2004

(54) Method and system for providing funds for on-line gaming

(76) Inventor: Jerry Kavoun, Nepean (CA)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/352,475

(22) Filed: Jan. 28, 2003

(51) Int. Cl. G06F 17/60

(52) U.S. Cl. 705/39

(57) ABSTRACT

A method for enabling on-line gaming involves a proxy account system adapted to receive statements of deposit from a proxy account holder. The statement of deposit includes an amount and a bank account number, and permits the proxy account holder to transfer the unconfirmed funds to an on-line gaming facility. The on-line gaming facility is notified that the funds have been transferred, but have not been confirmed, and consequently provide the gaming in a roll-back mode, which permits the gaming session to be annulled. The on-line gaming facility may also be provided with a track record of the proxy account holder viz. previous inaccurate statements of deposit. A proxy account system provides interfaces for Internet access and secure banking deposits, a records management unit, and an access controller that restricts access to the proxy account to the proxy account holder.

### CROSS-REFERENCE TO RELATED APPLICATIONS

This is the first application filed for the present invention.

### MICROFICHE APPENDIX

Not Applicable.

### TECHNICAL FIELD

The invention relates to payment methods for on-line gaming, and, in particular, to a method and a system for providing funds for on-line gaming. BACKGROUND OF THE INVENTION

On-line gaming has broad appeal. Participants can access favorite games from anywhere telecommunications equipment is available, and game providers can operate with a substantially decreased overhead as compared to a gaming establishment such as a casino or bingo hall. However, there are difficulties associated with the exchange of money over the Internet.

When on-line gaming was first introduced, a popular method of Internet payment involved the use of credit cards. However, this method of payment is being phased out because credit card companies, who view the transactions as too risky, are refusing to permit such transactions.

Where permitted by law, bank accounts can be accessed by third parties (e.g. a clearinghouse, a broker, a trusted third party, etc) with permission of the account holder. Such third parties may provide virtual wallets and the like, for the account holder. However, many people are reluctant to allow third parties access to their bank accounts. Moreover, in certain jurisdictions third-party access to personal banking accounts is forbidden by law. Accordingly, those who wish to participate in on-line gaming are constrained by lack of on acceptable payment method and game providers have a restricted clientele.

In many jurisdictions, however, systems are in place to provide electronic bill payment. The electronic bill payment can be effected using on-line banking, telephone banking, ATM banking, etc. As is taught by Shields et al. in Canadian Patent Application 2,319,919, entitled ON-LINE PAYMENT SYSTEM, the bill payment mechanism can be used to create a virtual wallet for on-line transactions. The system provides a subscriber with an opportunity to transfer funds (using the electronic bill payment system) to an account of the third party, and further to indicate an amount of funds has been transferred to the wallet. The transfer of funds generally takes about a working day, and in the interim, the third party provides the subscriber with an ability to provisionally spend “uncleared” funds in the virtual wallet. If the funds are not provided by the subscriber, by transactions that the subscriber initiated are cancelled. Accordingly a vendor who receives a request for a product or service with uncleared funds, waits until the funds are cleared before shipping the product or providing the service.

While Shields et al. provide a method for facilitating some aspects of electronic commerce, provisional expenditures are not available for all types of transactions. For example, services that are provided substantially instantaneously cannot be provided using the uncleared funds. Accordingly the user may not participate in on-line gaming until the funds are cleared, which takes a minimum of one business day, as noted above.

Accordingly there remains a need for a method of payment that enables immediate participation in on-line games for people who have bank accounts that cannot be accessed electronically by a third party such as a clearing house.

### SUMMARY OF THE INVENTION

An object of the invention is therefore to provide a method of on-line payment that permits immediate participation in on-line gaming.

The invention therefore provides a method for enabling on-line gaming. The method comprises steps of receiving at a proxy account system a statement of deposit from a proxy account holder indicating a stated amount of money deposited into a proxy account using an electronic bill payment facility, and an indication of an on-line gaming facility at which at least a part of the stated amount is to be used to purchase gaming tokens; indicating to the on-line gaming facility that a gaming session using the purchased gaming tokens is to be played in a conditional mode; and providing an indication to the on-line gaming facility that the gaming session is null unless a confirmation of deposit of at least the stated amount is received by the proxy account system within a preset time limit.

The invention further provides a proxy account system for providing proxy accounts for on-line gaming. The proxy account system comprises a communications interface for exchanging messages over a network; a database for maintaining proxy account records, and for recording transactions; and application software that provides controlled access to proxy accounts. The application software is adapted to receive from the communications interface a statement by a holder of a proxy account indicating an amount of money deposited into a proxy account from a bank account using an electronic bill payment facility, at least a part of the amount of money to be used for purchasing gaming tokens from an on-line gaming facility, effect the sending of a conditional transfer message to the on-line gaming facility indicating the unconfirmed transfer of funds, and unless confirmation that the transfer of at least the stated amount is received within a preset time limit, indicate to the on-line gaming facility that any gaming session using the unconfirmed funds is null.

The method and the system in accordance with the invention therefore permit funds to be made available on an immediate basis to a player who wishes to purchase virtual gaming tokens for online gaming. The only proviso is that games played using the tokens are played in a conditional mode. In conditional mode, the game is subject to rollback. Unless the receipt of at least the purchase price of the gaming tokens is confirmed within a predetermined time period, the game is rolled back, and any tokens that are won during the conditional mode of gaming are forfeited.

### BRIEF DESCRIPTION OF THE DRAWINGS

Further features and advantages of the present invention will become apparent from the following detailed description, taken in combination with the appended drawings, in which:

FIG. 1 is a schematic block diagram illustrating a network in which the system in accordance with the invention may be deployed;

FIG. 2 illustrates principal components of an embodiment of a proxy account system in accordance with the invention;

FIG. 3 illustrates principal steps involved in a method of on-line payment for gaming, in accordance with the invention; and

FIGS. 4a,b are message flow diagrams illustrating principal messages used to effect the method of on-line payment for gaming, in accordance with the invention.

It should be noted that throughout the appended drawings, like features are identified by like reference numerals.

### DETAILED DESCRIPTION OF THE PREFERRED EMBODIMENT

The invention provides a method of payment that permits immediate access to on-line gaming. The method is secure and efficient, and relies on security measures provided by a bank or like financial institution to effect an electronic transfer of funds from a user account to a proxy account used to provide the funds for gaming.

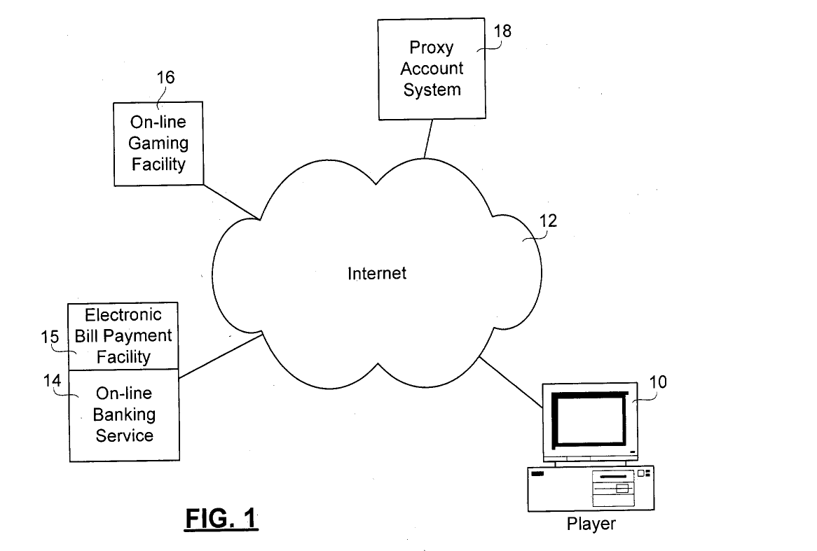

FIG. 1 illustrates a system in accordance with the invention deployed in a networked environment. A player 10, uses a computer for on-line gaming (a personal computer is illustrated, but the computer may be any networked devices that may be used to access the worldwide web, display web pages and used to complete web forms) The player's computer is connected to an Internet 12, or a data network that has access to the Internet 12, using modem connections over a plain old telephone service (POTS) line, a digital subscriber line (DSL), a cable modern, or a network card for direct connection to a network, such as an Ethernet network with a gateway to the Internet 12. The player 10 can therefore access the world-wide web using a web browser for receiving web pages and presenting them.

As is well known, on-line banking services are currently available. In accordance with the invention, on-line banking services 14 are not modified in any way, except to enroll the proxy account system 18 as a payee in an electronic bill payment system 15 of an on-line banking service 14. The on-line banking service 14, provides the player with access to the player's bank account, to permit the player 10 to perform different kinds of transactions, including a facility for paying bills to pre-registered service providers. This bill payment method is enabled by the electronic bill payment facility 15 in a manner well known in the art.

On-line gaming facilities, such as on-line casinos or event wagering sites, etc. are also well known in the art. In accordance with the invention, an on-line gaming facility 16 enters a service provision agreement with the proxy account system 18. The on-line gaming facility 16 is modified in accordance with the invention to provide a conditional play mode so that any gaming session played in this mode can be “rolled back” if the player 10 is playing with unconfirmed funds and confirmation of receipt of the funds is not confirmed within a predetermined time period. The on-line gaming facility 16 is further modified to permit any gaming proceeds to be transferred to the player's proxy account. Rolling back a game session has the effect of annulling the gaming session, as if it had never occurred.

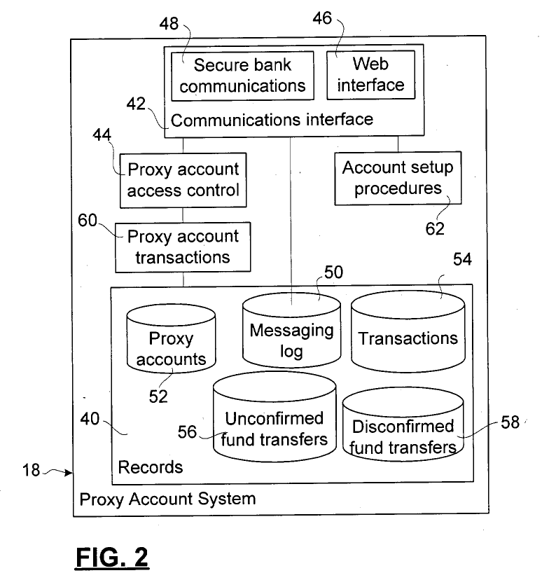

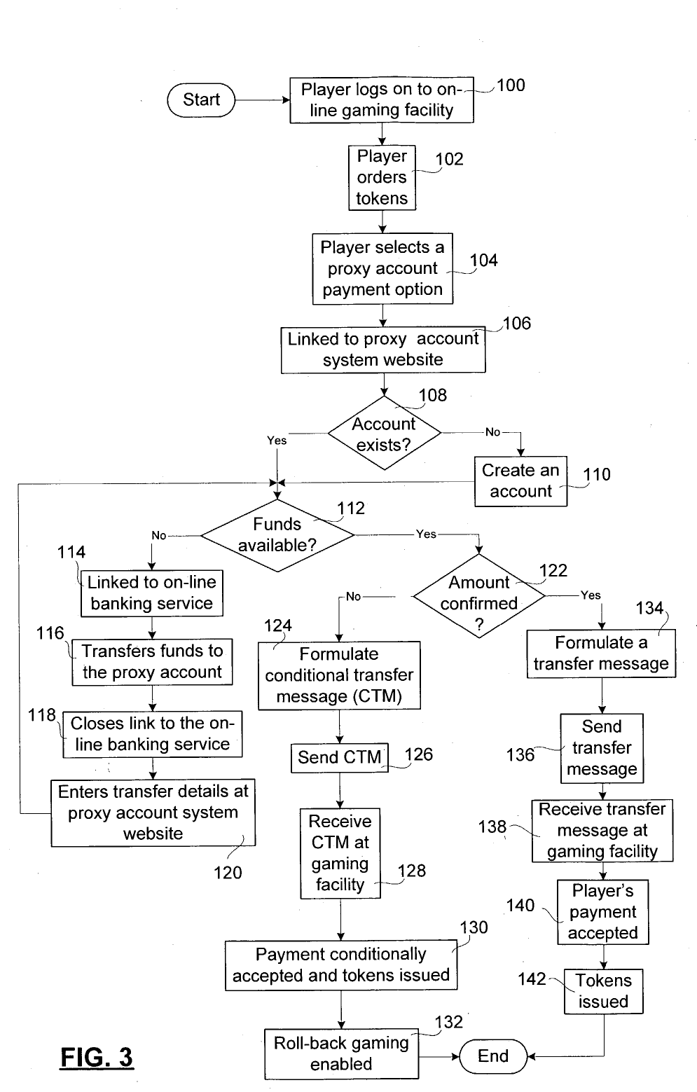

The proxy account system 18 is a transaction mechanism that provides a user-friendly interface, which makes transactions easy to effect and serves as a trusted proxy between the on-line gaming facility 16 and the player 10. Although only one on-line gaming facility 16 is illustrated, the proxy account system 18 is preferably adapted to serve a plurality of game players who can choose to play at a plurality of on-line gaming facilities 16. Consequently the proxy account system 18 provides a convenient interface for effecting proxy account transactions. The operations and components of the proxy account system 18 are further described below, principally with reference to FIG. 2.

Functional components of an embodiment of a proxy account system 18 in accordance with the invention are illustrated in FIG. 2, including a records management system 40, a communications interface 42 and application software.

The communications interface 42 of the present embodiment includes a world-wide web interface 46, and a secure communications facility 48. The world-wide web interface 46 serves web pages to account holders and the general Internet public. Commonly used dynamic web pages (such as active server pages and java server pages) having scripts (VB scripts, javascripts, etc.) for executing client-side and server-side functions can be used in known ways for facilitating communications between proxy account holders and the proxy account access control application 44. The world-wide web interface 46 may therefore comprise process server-side scripts (common gateway interface (CGI) scripts, servlets, server-side includes (SSIs), etc.) and the like, and for rendering dynamic web pages. The application software includes proxy account access control application 44 that governs content retrievable via the world-wide web interface 46. As well, messages sent and received are preferably stored in a messaging log 50 that indicates when a proxy account holder has performed a transaction, etc., in order to provide records for accounting and auditing purposes.

The secure communications facility 48 provides a secure path for receiving funds transfer (payment) notices from participating banks, and other financial institutions. As described above, the proxy account system 18 is registered as a service provider (payee) at each of the banks and other financial institutions providing respective on-line banking services. Players who hold accounts at the banks or other financial institutions can therefore deposit money into their proxy account using the electronic bill. payment facility 15, in a manner known in the art. Any communications path for receiving funds transfer notices from the bank can also be used in accordance with the invention. However, the notices are preferably electronic, which facilitates integration with the proxy account system 18 functions, and permits auditing of records. Electronic messages received via the secure communications facility 48 are automatically forwarded to the messaging log 50, and can be used to trigger a matching procedure for determining a related, unconfirmed funds deposit to a player's proxy account.

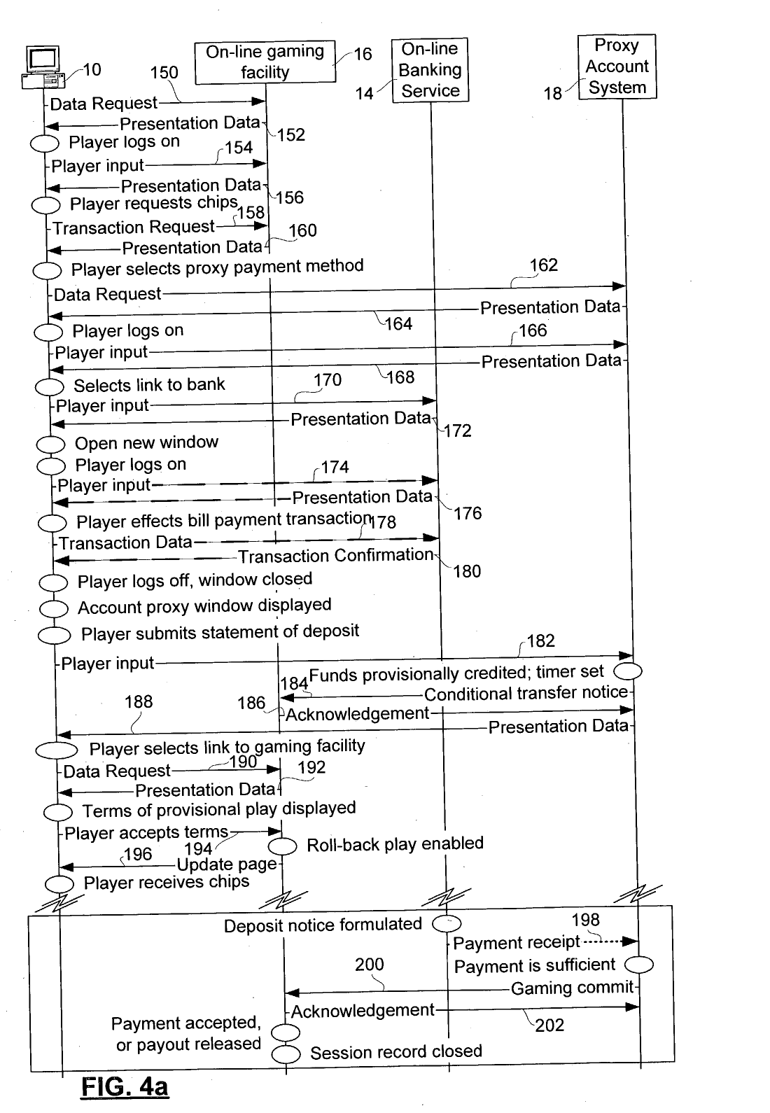

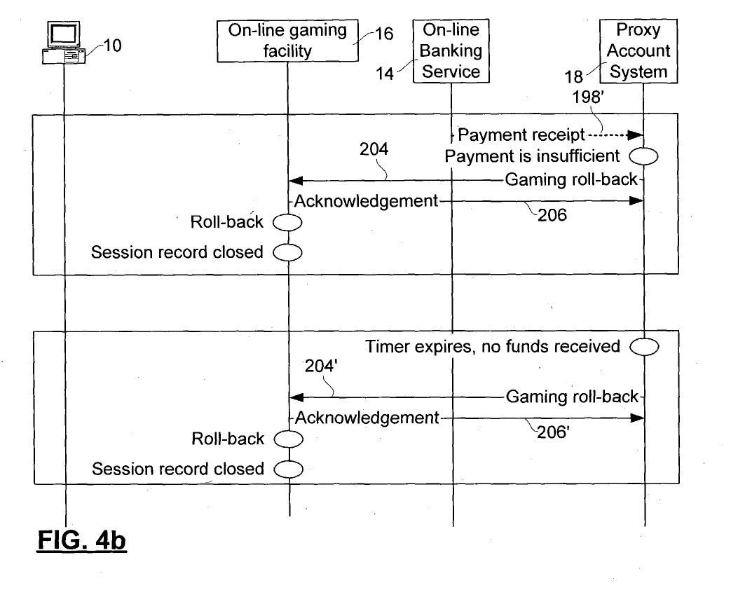

The records management system 40 preferably includes proxy account records 52, transaction records 54, unconfirmed transfer records 56 and disconfirmed transfer records 58. The proxy accounts records 52 store player proxy account information, including a current balance for each proxy account. Account history can be accessed by authorized individuals using the transaction records 54, which are preferably stored in a relational database that permits searches by proxy account, transaction time, transaction requester, transaction recipient, value of transaction, etc. The proxy accounts records 52 store at least a confirmed balance and an unconfirmed balance expressed in a currency associated with the account. Of course, the balances may optionally be expressed in other currencies as well. The transaction records 54 contain all transactions associated with a player 10 for a period of time dictated by regulations that govern the player 10 and/or the proxy account system 18. As described above, account holders are permitted to begin gaming before a deposit of funds to the proxy account system 18 has been confirmed by the bank or other financial institution. Accordingly, transaction records related to the unconfirmed transfers of funds are maintained in the unconfirmed transfer records 56. The unconfirmed transfer records 56 store a complete record of a statement of deposit made by the proxy account holder, including the bank account from which the funds were transferred, an amount transferred, and a time limit that is established when the account holder submits the statement of deposit to the proxy account system 18, as will be further explained below in relation to FIGS. 3 and 4a,b.

If confirmation of deposit into the proxy account is received from the bank or other financial institution 14, the proxy account record 52 is updated to credit the confirmed funds and the unconfirmed funds balance is debited for the same account. The action subsequently taken by the proxy account system 18 depends on whether the confirmed amount is less than the reported unconfirmed amount in the associated statement of deposit made by the proxy account holder, as will be explained in detail below. The disconfirmed transfer records 58 are used to identify account numbers of players who have reported fund transfers that were not confirmed, to prohibit use of the same account for further transactions using the proxy account system 18.

The proxy-account access control application 44 controls user access to the proxy account system 18 using access control and security mechanisms that are well known in the art. Transaction processing is provided via a proxy account transactions module 60, which provides transaction processing to players 10 and provides instructions to the world-wide web interface 46 for generating and sending web pages to the players 10. An account setup module 62 can be accessed through the world-wide web interface 46 to permit players 10 open accounts.

FIG. 3 is a flow chart that illustrates principal steps involved in using the proxy account system 18 in accordance with the invention. In step 100, a player 10 logs on to an on-line gaming facility 16. The player requests gambling tokens (step 102), which may be virtual chips or any other instrument of gaming that represents a monetary value to be wagered. The tokens are typically virtual objects that are displayed to the player. In step 104, the player selects a proxy account payment option from a list of methods of payment available from the on-line gaming facility web page (not shown). By virtue of the selection of the payment option, the player is linked to the proxy account system 18 web site (step 106) and the amount required to pay for the tokens ordered is passed to the proxy account system 18. In step 108, the player is presented a web page by the proxy account system world-wide web interface 46 (FIG. 2), which prompts the player to log on to access an existing proxy account. If the player does not already have a proxy account, a set of web pages are presented to guide the player 10 through the creation of a new proxy account (step 110). During that process, the player 10 must supply data required to identify himself/herself, agree to terms of use, supply passwords or other access control information, etc.

In step 112, it is determined whether the proxy account associated with the player contains sufficient funds to pay for the tokens ordered. If the required funds are not available in the account (whether confirmed or unconfirmed), the player may opt to transfer funds into his proxy account from a specified financial institution, by selecting an on-line banking service at which the player has on-line banking privileges. The selection of the on-line banking service has two effects: it opens a new window in which the banking service home page is displayed, and it sends a message to the world-wide web interface 46, instructing it to load a statement of deposit form into an inactive proxy account system page underlying the active banking service page.

In step 114, the banking service page is displayed in the new window. The player effects the transfer of funds to the proxy account using the electronic bill payment facility 15, in a manner that is well known in the art (step 116). When the player has completed the transaction (and any other on-line banking transactions desired) a log out procedure is initiated, resulting in the termination of a secure connection between the player 10 and the online banking service 14 (step 118). The window that displayed the banking service web page is closed, and the inactive page in background is displayed to the player 10, which contains the form to be used for supplying the statement of deposit. The player 10, in step 120, enters the bank account number, amount transferred and any other required details about the transfer, and submits the form to the proxy account system 18. Preferably, checks are made by the proxy account system 18 to ensure that the proxy account balance after the deposit reported in the statement of deposit is at least adequate to cover the gaming tokens purchased by the player 10. If the account balance is not adequate, or considerably more than required is transferred, appropriate warnings (not shown) are preferably displayed to the player 10 using a hypertext transfer protocol (HTTP) “push” or the like. The procedure then returns to step 112.

In an embodiment of the invention, the bank account number is checked against a list of bank account numbers in the disconfirmed transfer records 58. If a match is found, the proxy account system 18 may offer the player an option to repay the amount owed in relation to a previous gaming session, and may otherwise refuse to serve the player 10. The proxy account system 18 may also provide an explanation to the proxy account holder of the terms and conditions of conditional play, or categorically refuse to provide the proxy account holder with access to the proxy account. Alternatively, the proxy account system 18 may have an arrangement with the on-line gaming facility 16 whereby the proxy account system 18 notifies the on-line gaming facility 16 of the player's record and the on-line gaming facility 16 may impose restrictions on play, require payment before further play can continue, or impose other sanctions.

At this point, either confirmed or unconfirmed funds exist in the proxy account. It is determined, in step 122, whether the amount required to pay for the gaming tokens ordered on step 102 is available either as confirmed or (at least partially) unconfirmed funds. If the required funds are not all confirmed, in step 124, a conditional transfer message is formulated and sent from the proxy account system 18 to the on-line gaming facility 16. For security reasons the message may be sent over a secure network, a parallel network, or may be encrypted in any one of many ways known in the art. The message indicates that the funds are not confirmed. A proportion of the confirmed funds, if any, may be indicated. Concurrently, the player 10 is linked back to the on-line gaming facility 16 where the gaming tokens were ordered in step 102.

The on-line gaming facility 16 receives the conditional transfer message (step 128), accepts the conditional payment (step 130) and offers the player 10 terms of conditional play (step 132). If the player accepts the terms of conditional play (roll-back betting), the gaming tokens are issued, and the on-line gaming facility 16 provides the user with access to games that are provided in the roll-back mode, so that if the player's statement of deposit was inaccurate and not enough funds are available, the games can be annulled by the on-line gaming facility 16 regardless of an outcome of the gaming session.

If it is determined, in step 122, that the funds are all confirmed, an indication is provided (step 134) in a transfer message sent to the on-line gaming facility 16 (step 136). The on-line gaming facility 16 receives the transfer message (step 138), accepts payment of the funds (step 140), and supplies the player with the purchased tokens (step 142).

FIGS. 4a,b illustrates principal messages exchanged between the player 10, the on-line gaming facility 16, the online banking service 14, and proxy account system 18, in accordance with an exemplary use of the system in accordance with the invention. In step 150, the player 10 uses his computer to issue a request via the Internet 12 to the on-line gaming facility 16. The request is initiated by entering a uniform resource locator (url) of the on-line gaming facility's web site into a worldwide web browser, which effects the requisite actions for forwarding of the request message into the Internet 12.

The data request message generated in step 150 is forwarded through the Internet 12 to the on-line gaming facility 16. Upon receipt of the data request message, the on-line gaming facility 16 returns a web page associated with the url. In a manner well known in the art, the web page is returned through the Internet 12, in step 152.

The web page displayed to the player 10 provides text and user input fields that prompt the player 10 to log on, so that the player 10 can be identified. The player 10 therefore logs on by inserting log on information into the user input fields, and selecting a transmit button on the web page. A client-side script may effect a sequence of operations, to send the user input to the on-line gaming facility 16 (step 154), and modify the web page, as programmed. The on-line gaming facility 16 responds to the log on information and returns a web page that provides access to a virtual gaming room (not shown) step 156. The virtual gaming room includes a token vendor station where the player 10 requests chips of a specified value. This request generates a transaction request message that is forwarded to the on-line gaming facility 16 through the Internet 12 (step 158). A reply to the transaction request (step 160) provides the player 10 with a web page that prompts the player 10 to select a method of payment from a list of payment options.

The player 10 selects a proxy account method of payment. The selection links the player 10 to a home page of the proxy account system 18. Consequently, a data request message is sent from the player's computer to the proxy account system 18 (step 162). The proxy account system 18 returns the requested web page (step 164) to the player 10. The home web page presents the player 10 with options to log on to the proxy account system 18 or to create a new proxy account. The player 10, who in this example, already holds a proxy account, inputs log on information that is forwarded to the proxy account system 18 (step 186). Assuming there is no error in the proxy account log on information, presentation data is returned to provide the player 10 with a web page that enables account access, and provides links to banks and financial institutions that provide respective on-line banking services. The player 10 in this example does not have enough money in his proxy account to cover the chips requested, so the player 10 selects a link to an on-line banking service 14 with which he maintains a bank account.

The player 10 connects with the online banking service 14 (steps 170,172), and logs on to the banking service using secure IP connections (steps 174,176), in a manner well known in the art. The web page of the on-line banking service is displayed in a new window that over-lies the window that continues to display the proxy account system page. In step 178, the player 10 effects the transfer of funds into the proxy account using the electronic bill payment facility 15 of the on-line banking service 14. The transaction is confirmed (step 180), and the player 10 logs off of the on-line banking service 14. The window is either closed by the player 10, or is automatically closed by the log out procedure, and the account proxy web page that persisted throughout the banking transaction, is displayed.

The web page prompts the player 10 to input a statement of deposit regarding funds transferred to the proxy account. The player completes the statement of deposit, and submits the statement to the proxy account system 18, in step 182. The statement of deposit is used to update a plurality of records by the records management system 40 (FIG. 2), such as creating an unconfirmed transaction record, updating the messaging log and updating the unconfirmed account balance. Unconfirmed receipt of funds are credited to the player 10, and a timer or reminder is set to expire at a future time. The time of the reminder is sufficient for the determination of whether a transfer of funds has been effected. The timer or reminder may be set to expire or provide notice one working day after the deposit, or may be set to expire a time that depends on terms offered by the banking service 14, for example.

Preferably using a secure communications channel, in step 184, a conditional transfer message is sent from the proxy account system 10 to the on-line gaming facility 16. The conditional transfer message indicates that the funds have not been confirmed. This message is preferably acknowledged (step 186), and a web page is sent to the player 10 (step 188). The web page includes a link to the on-line gaming facility 16, and indicates that conditional play at the on-line gaming facility 16 is enabled for the player 10.

As will be apparent to those skilled in the art, the identity of the player 10 needs to be correlated with the conditional transfer message passed to the on-line gaming facility 16 in step 184. A simple way to accomplish this is by using a pair of correlated tags. One of the pair is inserted into the conditional transfer message sent to the on-line gaming facility in the step 184, and the other is embedded in the web page sent to the player 10, in step 188. When the link to the on-line gaming facility 16 is selected by the player 10, the other of the pair of correlated tags is inserted into a data request message sent in step 190. There are many other ways of correlating the identity of the player 10 with an electronic funds payment using confirmed or unconfirmed funds including requiring the player 10 to log back onto the on-line gaming facility 16, and enter a transfer number provided to him by the proxy account system 18 in step 188.

Assuming correlation tags, or some other automated correlation mechanism is used to link the player 10 to the transferred funds, in step 192, the on-line gaming facility 16 returns a web page to the player 10 and the web page displays all of the terms and conditions of conditional play. The player 10 must accept the terms and conditions by issuing an explicit response in order to proceed. In step 194, acceptance of the terms and conditions prompt the on-line gaming facility 16 to enable conditional play using the gaming tokens, and the web page presented to the player 10 is updated, in step 196, so that the player 10 can receive the purchased chips, and wager them within the context of the game(s) provided.

Generally, the player will win or lose gaming tokens during play, and will eventually end the gaming session. As it generally takes one working day for funds transferred using an on-line electronic bill payment facility to be confirmed to the proxy account system 18, the gaming sessions are almost invariably completed before confirmation of the funds is received. The on-line gaming facility 16 therefore maintains a record of the outcome of the gaming session, including payout owing as a result of the gaming session. The record is kept until the transfer of funds is confirmed to the proxy account system 16 by the on-line banking service 14, and, optionally, the proxy account system 16 transfers the funds to the on-line gaming facility 16.

In accordance with a first outcome, confirmation of the deposit is received by the proxy account system 18 (step 198). It is determined that the deposit was the same as, or more than, the amount stated by the player 10 in the statement of deposit. Any surplus is credited to the proxy account. Consequently the proxy account system 18 indicates the confirmation in gaming commit message sent to the on-line gaming facility 16 (step 200). The gaming commit message is acknowledged by the on-line gaming facility 16, in step 202. The on-line gaming facility 16 retrieves the gaming session record, and determines whether a payout is pending. If a payout is owed to the player 10, the on-line gaming facility 16 issues tokens or otherwise credits the player's account. Otherwise, the on-line gaming facility 16 records the payment due from the proxy account system 18, which is settled under agreement with the proxy account system 18 in a predetermined way.

In accordance with a second outcome, the funds actually transferred (notification of deposit received in step 198′, FIG. 4b) were less than the stated amount. Whatever funds are transferred, or remain in the proxy account of the player, may be forfeited by the player 10, and details extracted from the statement of deposit recorded in the disconfirmed transfer records 58 (FIG. 2). The proxy account system 18 then indicates that the funds have not been supplied in a gaming roll-back message sent to the on-line gaming facility 16 (step 204), which is acknowledged in step 206. The gaming session is therefore rolled back and annulled, as if it had never occurred. No payout or payment is recorded by the on-line gaming facility 16. The session record is closed.

If no funds are actually deposited into the player's proxy account, at a time corresponding with the statement of deposit, then details extracted from the statement of deposit are recorded in the disconfirmed transfer records 58 (FIG. 2), and steps 204, 206 are applied in much the same manner as if insufficient funds are deposited.

If a player 10 who has submitted a false statement of deposit returns to use the services of the proxy account system 18, the player 10 is asked to pay any outstanding amount, and if payment is not effected further service is denied. Although the player 10 may avoid detection by opening a new account on the proxy account system 18, any attempt to use the same bank account will be detected, and “bad account” management rules, such as described above, will be applied.

As will be appreciated, the method of payment provided to the on-line gaming facility 16 is a service for which the on-line gaming facility 16 is expected to reimburse the proxy account system 18. Any number of reimbursement structures may be applied, including a percentage of funds transferred, a per-transaction flat fee, a percentage of revenue from gaming sessions funded by the service, a flat rate, etc.

The examples described above are intended only to provide the general principles of provisioning and operation of an account proxy system in accordance with the invention. In general, the order of events presented is exemplary only. For example, the player 10 may deposit funds into the proxy account system 18 before visiting the on-line gaming facility 16. But it is important for the invention that the on-line gaming facility 16 receive the conditional transfer message at any time that unconfirmed funds are used by the player 10 to purchase gaming tokens, because that message triggers the conditional mode of play described above.

The embodiments of the invention described above are intended to be exemplary only. The scope of the invention is therefore intended to be limited solely by the scope of the appended claims.

I claim:

1. A method for enabling on-line gaming, the method comprising:
receiving at a proxy account system a statement of deposit from a proxy account holder indicating a stated amount of money deposited into a proxy account using an electronic bill payment facility, and an indication of an on-line gaming facility at which at least a part of the stated amount is to be used to purchase gaming tokens;
indicating to the on-line gaming facility that a gaming session using the purchased gaming tokens is to be played in a conditional mode; and
providing an indication to the on-line gaming facility that the gaming session is null unless a confirmation of deposit of at least the stated amount is received by the proxy account system within a preset time limit.

2. The method as claimed in claim 1 wherein prior to the receiving at the proxy account system, the method further comprises providing the proxy account holder with a statement of deposit form that the proxy account holder completes by inputting required data, and returns to the proxy account system.

3. The method as claimed in claim 2 wherein the receiving of the indication happens before the proxy account holder visits the on-line gaming facility.

4. The method as claimed in claim 1 wherein the receiving of the indication comprises receiving a message from the on-line gaming facility indicating a requested amount of funds input by the proxy account holder before the proxy account holder was linked to the proxy account system.

5. The method as claimed in claim 4 wherein, prior to providing the proxy account holder with a statement of deposit form, the receiving at a proxy account system further comprises providing the proxy account holder with a link to an on-line banking service selected by the proxy account holder, to permit the proxy account holder to use the electronic bill payment facility to effect the deposit.

6. The method as claimed in claim 5 wherein the indicating to the on-line gaming facility comprises sending a conditional transfer message over a secure communications channel to the on-line gaming facility.

7. The method as claimed in claim 6 wherein the sending of the conditional transfer message comprises first formulating the conditional transfer message in accordance with a predefined format, and inserting into the conditional transfer message the requested amount of funds to be transferred to the on-line gaming facility, and an identifier used by the online gaming facility to correlate the conditional transfer message with the proxy account holder that follows a link to the on-line gaming facility.

8. The method as claimed in claim 7 wherein the providing an indication to the on-line gaming facility comprises generating and sending a roll-back message.

9. The method as claimed in claim 7 further comprising sending a commit message to the on-line gaming facility to indicate that funds have been confirmed and to either accept payment of the funds, or release winnings to the proxy account holder in accordance with an outcome of the gaming session, once the deposit of at least the stated amount is received by the proxy account system, prior to the preset time limit.

10. The method as claimed in claim 2 further comprising:
verifying whether the proxy account has previously been used to make false statements of deposit, and applying responsive measures, accordingly.

11. The method as claimed in claim 10 wherein verifying comprises accessing disconfirmed transfer records to determine if a record exists in relation to the proxy account.

12. The method as claimed in claim 10 wherein verifying comprises accessing disconfirmed transfer records to determine if a record exists in relation to an account specified by the proxy account holder.

13. The method as claimed in claim 10 wherein the applying of responsive measure comprises at least one of: providing the account holder with an option to repay an outstanding amount; refusing to permit gaming with unconfirmed funds; and explaining conditions of use.

14. A proxy account system for providing proxy accounts for on-line gaming, the proxy account system comprising:
a communications interface for exchanging messages over a network;
a database for maintaining proxy account records, and for recording transactions; and
application software that provides controlled access to proxy accounts, the application software adapted to:
receive from the communications interface a statement by a holder of a proxy account indicating an amount of money deposited into a proxy account from a bank account using an electronic bill payment facility, at least a part of the amount of money to be used for purchasing gaming tokens from an on-line gaming facility;
effect the sending of a conditional transfer message to the on-line gaming facility indicating the unconfirmed transfer of funds; and
unless confirmation that the transfer of at least the stated amount is received within a preset time limit, indicate to the on-line gaming facility that any gaming session using the unconfirmed funds is null.

15. A proxy account system as claimed in claim 14 wherein the communications interface comprises web server functionality, and the network comprises the Internet.

16. A proxy account system as claimed in claim 15 wherein the web server functionality is further adapted to serve web pages containing server-side scripts and client-side scripts.

17. A proxy account system as claimed in claim 14 wherein the web server functionality is further adapted to provide a web site for registering to receive a proxy account.

18. A proxy account system as claimed in claim 14 wherein the web server functionality is further adapted to provide a web site where proxy account holders can access respective proxy accounts to perform account transactions.

19. A proxy account system as claimed in claim 14 wherein the communications interface further comprises a secure communications interface for receiving messages from a banking institution providing the bank account indicating a deposit of money into an account belonging to management of the proxy account system.

20. A proxy account system as claimed in claim 14 wherein the database comprises a relational database providing access to archived transactions.

21. A proxy account system as claimed in claim 14 wherein the database provides expedited access to account balances when queried by account number.

22. A proxy account system as claimed in claim 14 wherein the database provides a list of proxy account holders and bank account numbers that have been implicated in incorrect statements of deposit.

23. A proxy account system as claimed in claim 14 wherein the database comprises a set of records of deposits that are pending confirmation.

24. A proxy account system as claimed in claim 14 wherein the software application comprises a proxy account access control application for restricting access to proxy accounts to their respective holders using passwords and user identifiers.

25. A proxy account system as claimed in claim 14 wherein the software application comprises proxy account transactions module for effecting proxy account transactions, including the transferring of funds to respective other parties at the request of the proxy account holder.
